(19) United States
(12) Patent Application Publication
(10) Pub. No.: US 2005/0081675 A1
(43) Pub. Date: Apr. 21, 2005

(54) Steering apparatus

(75) Inventors: Morito Oshita, Kariya-shi (JP); Yasuaki Kurokawa, Kariya-shi (JP); Masakazu Ozawa, Aichi-gun (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/968,335

(22) Filed: Oct. 20, 2004

Related U.S. Application Data
(63) Continuation-in-part of application No. 10/855,558, filed on May 28, 2004.

(30) Foreign Application Priority Data
May 30, 2003 (JP) 2003-154872
Mar. 12, 2004 (JP) 2004-071289

(51) Int. Cl. B62D 1/16

(52) U.S. Cl. 74/493; 74/492

(57) ABSTRACT

A steering apparatus includes a steering wheel, a steering column connected to the steering wheel at one end of the steering column, a column supporting member rotatably supporting the steering column relative to a vehicle body, and a column swinging member rotatably supporting the steering column for swinging the steering column about a column swinging point on the column swinging member. A distance (LS) between the column swinging point and a column supporting point provided at the column supporting member is equal to or greater than 30% of distance (LH) between the column swinging point and the steering wheel.

### CROSS REFERENCE

This application repeats a substantial portion of prior Application No. 10/855,558, filed on May 28, 2004, and adds and claims additional disclosure not presented in the prior application. Since this application names an inventor or inventors named in the prior application, it may constitute a continuation-in-part of the prior application. Should applicant desire to obtain the benefit of the filing date of the prior application, attention is directed to 35 U.S.C. 120 and 37 CFR 1.78.

This application is based on and claims priority under 35 U.S.C. §119 with respect to Japanese Applications No. 2003-154872 filed on May 30, 2003 and No. 2004-071289 filed on Mar. 12, 2004, the entire contents of which are incorporated herein by reference.

### FIELD OF THE INVENTION

This invention generally relates to a steering apparatus for a vehicle.

### BACKGROUND OF THE INVENTION

A known steering apparatus for a vehicle includes a tilt mechanism for adjusting an inclination of a steering column by a drive force of a motor provided in the vicinity of a steering shaft.

The U.S. Pat. No. 4,925,210, for instance, discloses such a steering apparatus for a vehicle including an electric motor 141 attached to an outer periphery of a steering column 200 as shown in FIGS. 5 and 6. The rotation force of the electric motor 141 is transmitted to a gear 140 engaging with a tip end portion of a rotating shaft of the motor 141 and a gear 144 via a chain 142. At this time, the gears 140 and 144 are rotated to thereby move spindles 131 and 132 in the vertical direction in FIG. 5, the spindles 131 and 132 serving as a shaft of each disk 137 having a screw bore and integrally supporting the steering column 200. That is, the steering column 200 is pivoted in the vertical direction of the vehicle since the respective positions of the screw bores of the spindles 131 and 132 move in the vertical direction.

According to the disclosed steering apparatus, the steering column 200 is supported by the vertically moving mechanism geared with the two spindles, the driving force from the motor is not transmitted equally to the vertically moving mechanism in case the center axes of the both spindles deviate. The high precision of the spindles are required accordingly. A rigidity of the steering column 200 is required because the steering column 200 is supported by the two spindles.

The position of the steering wheel is adjusted for a driver in the vehicle. The steering column is vertically moved for adjusting the position of the steering wheel by the motor. A large operating force is required for vertically moving the steering column in case a heavy load such as the driving mechanism for tilting is attached to the steering column. Thus, a motor becomes large.

When the center of the tilting is provided at the steering wheel side from the motor for tilting, the large motor is not required. However, a tilting angle of the steering wheel is rapidly changed if the position of the center of the tilting is changed without any consideration.

Recently, an column integrally structured with a power steering is employed. For the column integrally structured with the power steering, a driving mechanism, a motor, and the like provided around the steering column occupies a large space. Embedding of the tilting mechanism for tilting is difficult because of lacking of the large space.

A need thus exists for a steering device having simple structure, high rigidity, wide range for vertically moving the steering column relative to the vehicle, and small occupying space.

### SUMMARY OF THE INVENTION

According to an aspect of the present invention, a steering apparatus includes a steering wheel, a steering column connected to the steering wheel at one end of the steering column, a column supporting member rotatably supporting the steering column relative to a vehicle body, and a column swinging member rotatably supporting the steering column for swinging the steering column about a column swinging point on the column swinging member. A distance (LS) between the column swinging point and a column supporting point provided at the column supporting member is equal to or greater than 30% of distance (LH) between the column swinging point and the steering wheel.

### BRIEF DESCRIPTION OF THE DRAWINGS

The foregoing and additional features and characteristics of the present invention will become more apparent from the following detailed description considered with reference to the accompanying drawings, wherein:

FIG. 1 shows a external side-view of a steering apparatus 1 according to a first embodiment of the present invention.

FIG. 2 shows a cross-sectional view of the steering apparatus taken from FIG. 1.

FIG. 3 shows a partial cross-sectional view of the steering apparatus according to a second embodiment of the present invention.

FIG. 4 shows a cross-sectional view taken on line IV-IV of FIG. 3.

FIG. 5 shows a cross-sectional view taken on line V-V of FIG. 3.

FIG. 6 shows an explanatory figure showing a normal state of the steering apparatus shown in FIG. 3.

FIG. 7 shows an explanatory figure showing the steering apparatus in a state that load is applied to the steering wheel shown in FIG. 6 in axis direction of the steering wheel.

### DETAILED DESCRIPTION

A first embodiment of the present invention will be explained with reference to the illustrations of the drawing figures as follows.

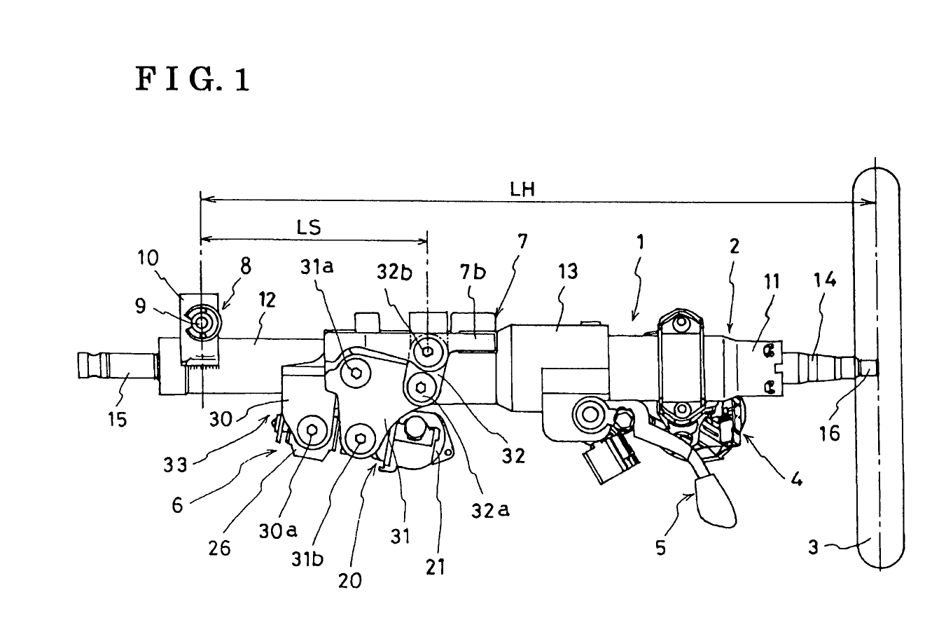

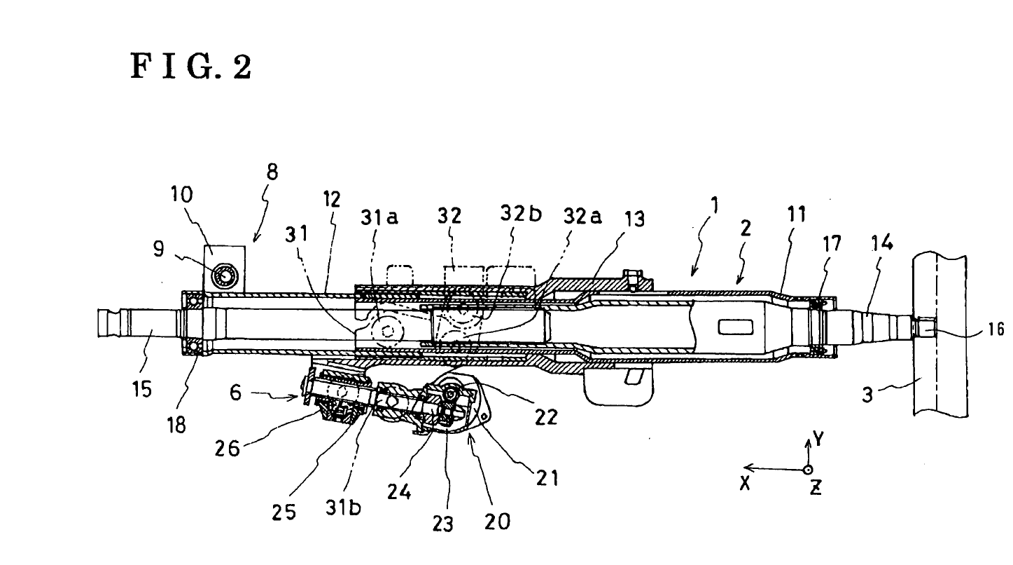

FIG. 1 shows a side-view of a steering apparatus 1 embedded in a vehicle according to the first embodiment of the present invention. FIG. 2 shows a partial cross-sectional view of the steering apparatus 1 showing an internal structure thereof.

The steering apparatus 1 mainly includes a steering column 2 provided in a diagonal direction relative to a back and forth direction of the vehicle, a steering wheel 3 attached to an end portion 16 of a first shaft 14 in the steering column 2 for a steering operation by a driver, a key cylinder 4 provided at the steering column 2 of the steering wheel 3 side operated by a vehicle key, a locking mechanism 5 for moving the steering wheel 3 in an axial direction of the steering wheel 3 and for locking the steering wheel 3 at a predetermined position where a driver intends to, a tilting mechanism 6 provided under the steering column 2 for rotating the steering column 2 about a column swinging point 9 to vertically move the steering wheel 3 relative to the vehicle.

The steering apparatus 1 is fixed to a supporting member of the vehicle provided at a space defining a vehicle room and an engine room therebetween provided in front of a seat for the driver via a first fixing portion 7 and a second fixing portion 8 of the steering apparatus 1. The first fixing portion 7 is provided substantially a center of the steering column 2. The second fixing portion 8 is provided in a front portion of the steering column 2 relative to the back and forth direction of the vehicle. The steering apparatus 1 is fixed to the vehicle via the first fixing portion 7 and the second fixing portion 8. The first fixing portion 7 includes a fixing bracket 7b having a rectangular opening portion at a center of the first bracket 7b and a pair of flange-like side walls at ends of the first bracket 7b respectively. A linking mechanism 33 is connected to the fixing bracket 7b via a pivot 32b serving as a second rotation axis. The pivot 32b is provided to penetrate in a z-axis direction. The pivot 32b is rotatable relative to the fixing bracket 7b. The pivot 32b functions as a column supporting point 32b for supporting a middle portion of the steering column 2.

The second fixing portion 8 includes a bracket 10 having an substantially U-shape provided in the front portion of the steering column 2. The bracket 10 is fixed to an external surface of a second column tube 12 provided at the front portion of the steering column 2. The second column tube 12 is provided along a center axis of the steering column 2 from a side view of FIG. 1. The column swinging point 9 is provided substantially a center of the bracket 10. The steering column 2 is rotatable about the column swinging point 9.

For explanatory purpose, a distance in x-axis direction between the column swinging point 9 on the second fixing portion 8 and a center line of the steering wheel 3 is defined as LH as shown in FIG. 1. Similarly, a distance between the column swinging point 9 and the column supporting point 32b is defined as LS. The distance LS is set equal to or greater than 30% of the distance LH in the steering apparatus 1 according to the first embodiment. The steering wheel 3 is operated by the driver for steering wheels. The structure of the steering apparatus 1 has to be rigid to restrain a vibration transmitted to the steering apparatus I while the vehicle is driving. Because the column supporting point 32b and the column swinging point 9 provided at the second fixing portion 8 are positioned to satisfy a condition that the distance LS is set equal to or greater than 30% of the distance LH, a heavy load is not transmitted to the column supporting point 32b provided between the steering wheel 3 and the column swinging point 9 even when a load in a vertical direction (y-direction) is applied to the steering wheel 3. Thus, the steering apparatus 1 may be structured to have an improved rigidity.

An internal structure of the steering column 2 is explained with reference to FIG. 2. The steering column 2 includes following parts coaxially provided. The steering column 2 includes a hollow first column tube 11 having bulged portion in center thereof, the hollow second column tube 12 into which a front end (a left end in x-axis direction) of the first column tube 11 is inserted, a hollow tube housing 13 for protecting an overlapped portion of the first column tube 11 and the second column tube 12. The first column tube 11, the second column tube 12, the tube housing 13 are made from aluminum for the purpose of a weight saving, and are coaxially provided. The front end of the first column tube 11 has a smaller diameter than a diameter of a back end of the second column tube 12 so that the first column tube is inserted into the back end of the second column tube 12. The first column tube 11 is slidably inserted into the second column tube 12. The steering wheel 3 is connected to an end portion 16 of the first shaft 14. A bearing 17 is provided at a back end of the first column tube 11. A bearing 18 is provided at a front end of the second column tube 12. The first shaft 14 and a second shaft 15 are supported in both the first column tube 11 and the second column tube 12 by both the bearing 17 and the bearing 18. The first shaft 14 and the second shaft 15 having an identical axis are rotatably provided in the first column tube 11 and the second column tube 12 and the tube housing 13. The first shaft 14 and the second shaft 15 are rotatably supported by the two bearings in the first column tube 11 and the second column tube 12. The first shaft 14 and the second shaft 15 are engaged by a spline to be slidable in the x-axis direction. The driver fixes a sliding position of the second column tube 12 in the x-axis direction relative to the first column tube 11 at the predetermined position where the driver intends to by manually operating an operating lever of the locking mechanism 5. This sliding operation is a telescopic operation of the steering apparatus 1.

The tilting mechanism 6 will be explained as follows. The tilting mechanism 6 includes the linking mechanism 33 including a first link 30, a second link 31 and a third link 32 provided around the steering column 2 (under the steering column 2). The linking mechanism 33 performs a tilting operation of the steering wheel 3 by rotating the steering column 2 about the column swinging point 9 by a motor 21 of a driving mechanism 20, thereby moving the end portion 16 to which the steering wheel 3 is connected.

The driving mechanism 20 mainly includes the motor 21, a worm gear 22, a wheel gear 23, a tilt worm 24 and a slider 26. The worm gear 22 is engaged with an output axis of the motor 21 serving as a driving source. The wheel gear 23 is engaged with the worm gear 22. A first end of the tilt worm 24 in the x-axis direction is inserted to the wheel gear 23. Thus, the wheel gear 23 is rotated as a unit with the tilt worm 24. The tilt worm 24 is supported by two bearings in a second link 31 side of a housing. Both ends of the tilt worm 24 in a z-axis direction is supported by the first link 30 and the second link 31. A gear 25 is formed around an periphery of an other end of the tilt worm 24 in the x-axis direction. The slider 26 is movably engaged with the gear 25. A stopper for stopping a frontward movement of the slider 26 is provided at a first link 30 side of the slider 26. A stopper for stopping a backward movement of the slider 26 is provided at a second link 31 side of the slider 26. The slider 26 is movable in line by a predetermined distance engaging with the periphery of the tilt worm 24. A pivot 30a is provided to penetrate through the first link 30 in the z-axis direction under a front end of the tube housing 13. The slider 26 is supported at a lower portion of the first link 30 via the pivot 30a.

The linking mechanism 33 will be explained as follows. The first link 30 is formed at a front portion of the tube housing 13 as a unit with the tube housing 13. The lower portion of the first link 30 has a U-shape. The slider 26 is supported between the U-shaped first link 30 via the pivot 30a. The slider 26 is rotatable about the pivot 30a. The driving mechanism 20 including the motor 21 is supported by a lower portion of the second link 31. The second link 31 forms an substantially triangle shape in a side view and forms a L-shaped link. Three pivots 31a, 32a, 31b are provided to penetrate the second link 31. The second link 31 is rotatable via the pivot 31a relative to the first link 30. Further, the second link 31 supports an one end of the tilt worm 24 in the z-axis direction via the pivot 31b provided to penetrate the lower portion of the second link 31 in the z-axis direction. The second link 31 is connected to the third link 32 via the pivot 32a. The third link 32 has an I-shape. The third link 32 is provided between the second link 31 and the fixing bracket 7b of the fixing portion 7. A first end (a lower end) of the I-shaped third link 32 is rotatably supported via the pivot 32a provided to penetrate the second link 31 in the z-axis direction. A second end of the third link 32 is rotatably supported via the pivot 32b provided to penetrate the flange-like fixing bracket 7b in the z-axis direction. The three links 30, 31, 32 of the same shape are provided at both sides of the steering column 2.

As described above, the tilting mechanism 6 are connected to the steering column 2 via the three links 30, 31, 32. The pivot 31a is provided at the position close to a line connecting between the column swinging point 9 and the pivot 32a. Therefore, a load applied to the steering wheel 3 in vertical direction (downward in FIG. 1), or the like, is converted to a load transmitted along an axial line of the tilting mechanism 6 (along a line connecting between the pivot 30a and the pivot 31b). Because the axial line of the tilting mechanism 6 is rigid, the load is firmly supported thereby. Accordingly, the vibration of the steering wheel 3 (vibration induced from the load to the steering wheel 3 and vibration transmitted to the steering wheel 3 from an engine) is firmly restrained.

As described above, because the load transmitted to the pivot 32b is decreased corresponding to a distance ratio of the distance LS and the distance LH, the load transmitted to the pivot 31b of the second link 31 is also decreased. Thus, the load transmitted to the pivot 30a for supporting the steering column 2 against the load is also decreased. Accordingly, the load transmitted to the slider 26 applied from the steering wheel 3 is decreased. As a result, the tilting operation becomes smooth. The vibration transmitted to the steering wheel 3 is also decreased.

The tilting mechanism 6 will be explained as follows.

The tilting operation of the tilting mechanism is performed by the motor 21. When the motor 21 is operated, the output of the motor 21 is outputted to the worm gear 22 provided at the output axis of the motor 21. Then, the rotational motion of the worm gear 22 is transmitted to the wheel gear 23 engaged with the worm gear 22. The tilt worm 24 is rotated as a unit with the wheel gear 23. The rotational motion of the tilt worm 24 is transmitted to the slider 26. At this time, the slider 26 is rotatably supported via the pivot 30a not to move relative to the U-shaped armed portion of the link 30. Thus, the slider 26 does not move in the axial direction of the tilt worm 24. The motion of the tilt worm 24 in the axial direction is transformed to a swinging motion of the pivot 32a and the pivot 31b about the pivot 31a. Thus, the second link 32 is rotated relative to the first link 30 by the motor 21. For example, when the second link 31 is rotated about the pivot 31a clockwise in FIG. 1, the third link 32 is rotated clockwise. On the contrary, when the second link 31 is rotated counterclockwise, the third link 32 is rotated counterclockwise. Because the first fixing portion 7 is fixed to the vehicle body, the steering apparatus 1 swings in the vertical direction of the vehicle body about the column swinging point 9 relative to the first fixing portion 7 fixed to the vehicle body. Then, the position of the steering wheel 3 vertically moves.

An downward tilting operation (the steering wheel 3 is moved downward) is explained as follows. The motor 21 is driven in a regular direction for tilting steering wheel 3 downward. A sliding operation of the slider 26 is performed by the driving mechanism 20. With the sliding operation of the slider 26, the pivot 31b of the second link 31 is moved toward the steering wheel 3 (in a direction apart from the pivot 30a) relative to the pivot 30a of the first link 30 which is a unit with the tube housing 13. An angle of the driving mechanism 20 relative to the steering column 2 is gradually changed simultaneously. In accordance with the sliding operation in the driving mechanism 20, the second link 31 is rotated about the pivot 31a counterclockwise. The subtle motion of the pivot 32a of the second link 31 in the axial direction is absorbed by the third link 32. The steering column 2 is swung about the column swinging point 9 clockwise by the pivot 31a provided between the tube housing 13 and the second link 31. As a result, the steering wheel 3 is swung downward (the downward tilting operation).

Because the three links 30, 31, 32 are included in the linking mechanism 33 of the tilting mechanism 6 in the embodiment, the motion of the driving mechanism 20 is enhanced by the three links 30, 31, 32. Accordingly, even if the driving mechanism 20 slides in only small amount, a sufficient tilting motion is obtained from the driving mechanism 20.

In the structure described above, because the tilting mechanism 6 is operated via the links 30, 31, 32, the driving mechanism 20 does not has to be embedded between the first fixing portion 7 and the steering column 2. Accordingly, the embedding of the steering apparatus 1 becomes easy.

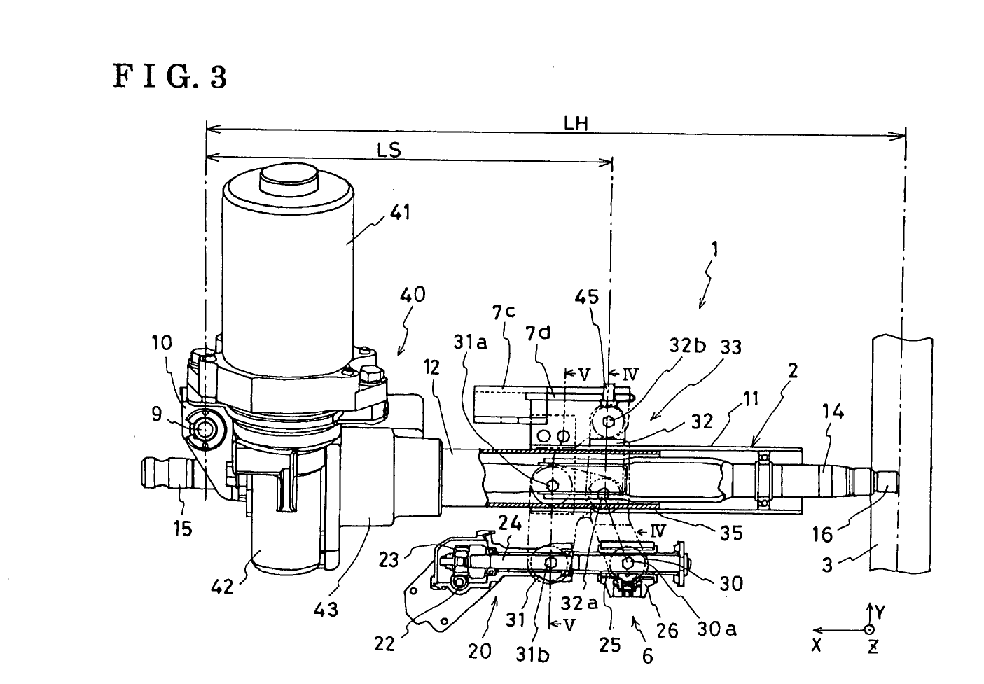

A second embodiment of the present invention is illustrated in FIG. 3. In the embodiment, the link mechanism 33 including three links described in the first embodiment is attached to a steering apparatus 1 including a power steering apparatus 40. For explanatory purpose, same number is applied for a member having same function in the first embodiment, and differences in the second embodiment from the first embodiment will be mainly explained.

The power steering apparatus 40 is added at a front portion of a steering column 2 shown in FIG. 3. The steering column 2 includes a hollow cylindrical second column tube 12 and a first column tube 11 having a larger diameter than a diameter of the second column tube 12. The second column tube 12 is coaxially inserted into the first column tube 11. The first column tube 11 and the second column tube 12 are overlapped at a middle portion of the steering column 2. A first shaft 14 to which a steering wheel 3 is connected at an end portion 16 thereof and a second shaft 15 are coaxially provided in the first column tube 11 and the second column tube 12.

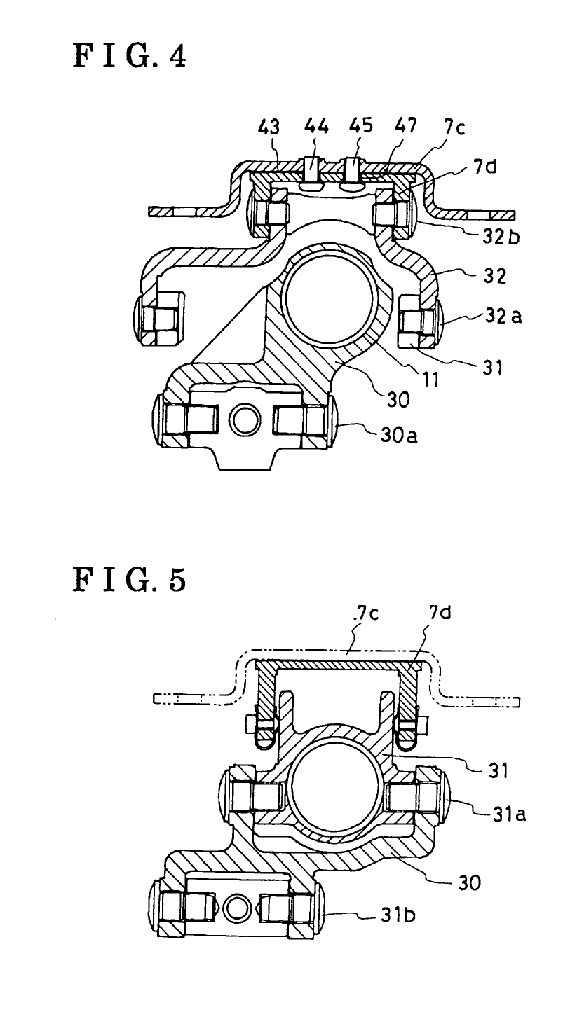

The power steering apparatus 40 is attached at a front portion of the second column tube 12. The power steering apparatus 40 includes a motor 41 for supporting a steering operation by an electric power, a decelerating mechanism 42 for supporting the steering operation by a driver by decelerating the output from the motor 41 by an internal gear. The motor 41 is formed as a single member with the decelerating mechanism 42 by a housing 43. The housing 43 is attached on an axis of the second column tube 12. The steering column 2 described above has a column swinging point 9 at a bracket 10 attached at a front portion of the housing 43. A front portion of the steering wheel 1 is attached to a supporting member of a vehicle body via the column swinging point 9. The steering apparatus 1 is also supported via a middle portion of the first column tube 11 and a column supporting point 32b to the supporting member of the vehicle body. The structure stated above in this section is already known. The characteristic point of the second embodiment is that the linking mechanism 33 is attached to the above known structure. The structure of the linking mechanism 33 is shown in FIG. 4 and FIG. 5. FIG. 4 shows a cross-sectional view taken on line IV-IV of FIG. 3. FIG. 5 shows a cross-sectional view taken on line V-V of FIG. 3.

A fixing bracket 7d having a U-shape at a cross-sectional surface thereof is provided at the first column tube 11 positioned outside of the steering column 2 and a fixing bracket 7c having a crank-shape is fixed at the supporting member of the vehicle body. The fixing bracket 7d is plate-like member. The fixing bracket 7d is fixed as a unit with the fixing bracket 7c positioned on the fixing bracket 7d via two screws 44, 45. A pair of slits of a predetermined length having a U-shape 46, 47 is formed in parallel. The two screws 44, 45 are inserted into the relative slits 46, 47 from the bottom of the fixing bracket 7d to up. Accordingly, the fixing bracket 7c, 7d are fixed as a unit. The slit 46, 47 have a function for an attachment hole for fixing the fixing bracket 7d by the screws 44, 45. The slit 46, 47 also have a function for releasing a lock between the vehicle body and the linking mechanism 33 when a load equal to or greater than a predetermined value from an axial direction (an x-axis direction) is applied to the steering wheel 3 attached at the end portion 16 of the first shaft 14 of the steering column 2.

The linking mechanism 33 attached to the first column tube 11 is briefly explained. The linking mechanism 33 described here is provided between the first column tube 11 of the steering column 2 and the fixing bracket 7d. The linking mechanism 33 includes three links 30, 31, 32 similar to the first embodiment. A structure and an effect of the linking mechanism 33 is fundamentally same as the first embodiment. In the second embodiment, a first link 30 is provided as a single member with the first column tube 11 provided outside of the second column tube 12. The first link 30 supports a slider 26 via a pivot 30a provided to penetrate the first link 30 in the z-axis direction. The first link 30 is supported relative to a second link 31 via a pivot 32a provided from both side of the first link 30 to penetrate the first link 30. Thus, the first link 30 is rotatable relative to the second link 31. A third link 32 is provided between the second link 31 and the fixing bracket 7d. The first column tube 11 of the steering column 2 is supported relative to the fixing bracket 7d via the third link 32.

The second link 31 is rotatable about a pivot 31a. A housing of a driving apparatus 20 including a worm gear 22, a wheel gear 23, a tilt worm 24 are rotatably supported via a pivot 31b at a lower portion of the second link 31.

A motion of the relative members when the linking mechanism 33 is operated by the driving mechanism 20 for a tilting operation is similar to a motion of them in the first embodiment.

In the second embodiment, a distance between the column swinging point 9 and the column supporting point 32b, in other words LS, is set about 60% of a distance between the column swinging point 9 and a center line of the steering wheel 3, in other words LH, to restrain a load transmitted to the column supporting point 32b and to improve a rigidity of the steering apparatus 1.

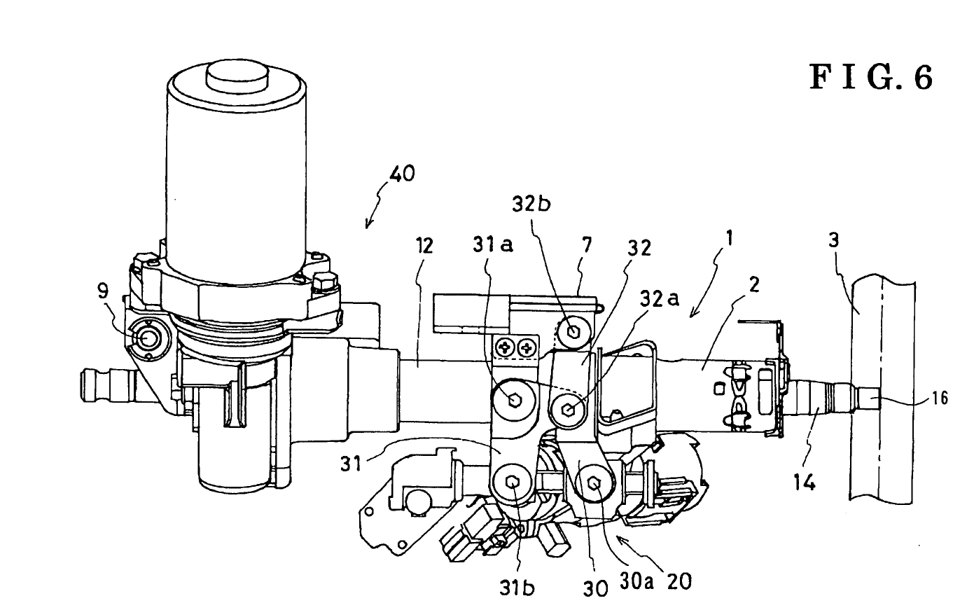

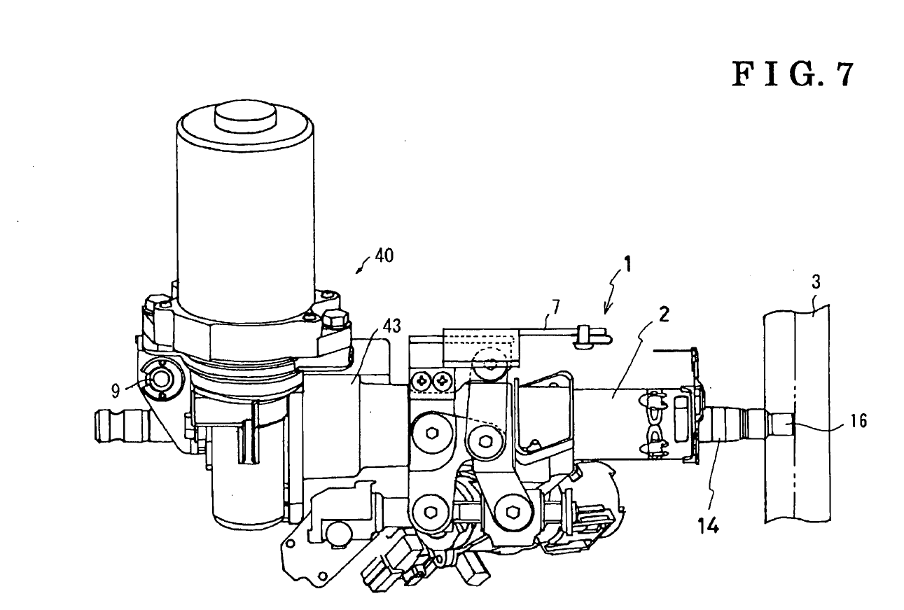

A case that a load equal to or greater than a predetermined value is applied to the steering wheel 3 from the axial direction (the x-direction) will be explained. When the load equal to or greater than the predetermined value is applied to the steering wheel 3 from the axial direction (the x-direction), the load is transmitted to the linking mechanism 33. When the load is transmitted to the linking mechanism 33, a relative movement between the screw 44, 45 attached at the fixing bracket 7c fixed to the vehicle side and the fixing brackets 7c, 7d becomes permitted. The fixing bracket 7d moves along the U-shaped slits 46, 47 of the fixing bracket 7c relative to the screws 44, 45 by friction force. When the position of the screws 44, 45 reached an end portion of the fixing bracket 7d in the axial direction, an engagement of the screws 44, 45 with the fixing bracket 7c, 7d becomes to be released. When the engagement of the screws 44, 45 with the fixing brackets 7c, 7d is released, a movement of the steering wheel 3 side in the axial direction of the steering apparatus 1 is permitted. As a result, the steering apparatus 1 becomes a shrunk state shown in FIG. 7 from a normal state shown in FIG. 6 corresponding to an amount of the load applied to the steering wheel 3 in the axial direction.

In case the vehicle encounters an accident and a load equal to or greater than a predetermined value is applied to the steering wheel 3 by an weight of an upper part of a body of the driver, a back end of the inner second column tube 12 is gradually inserted into the first column tube 11 along an inner wall of the first column tube 11 provided outside of the second column tube 12. The overlapped portion of the first column tube 11 and the second column tube 12 becomes gradually increased. A ring-shaped friction member 35 is provided between the first column tube 11 and the second column tube 12. The back end of the inner second column tube 12 is inserted to the first column tube 11 along the inner wall of the first column tube 11 against friction force of the friction member 35. A length of the steering column 2 becomes substantially short, and thus a length of the steering apparatus 1 becomes short in case the vehicle encounters the accident. Accordingly, the upper part of the body of the driver is protected. The fixing bracket 7d functions as a locking and releasing for releasing the engagement of the body side with the linking mechanism 33.

As described above, in the second embodiment, the linking mechanism 33 is added to the steering apparatus 1 having the power steering apparatus 40 provided on an axis of the steering apparatus 1. The linking mechanism 33 does not interfere a shrinking movement of the steering column 2 even in case the vehicle encounters the accident. The steering wheel 3 is operated for the tilting operation in the vertical direction without interfering a space occupied by the power steering apparatus 40.

As described above, in the second embodiment, the linking mechanism 33 is attached to the first column tube 11. However, an attaching position of the linking mechanism 33 is not restricted only to the first column tube 11. The linking mechanism 33 may be attached to a member in the steering apparatus 1, which is not moved in the axial direction of the steering apparatus 1 when the position of the steering wheel 3 is moved in the axial direction of the steering apparatus 1.

The distance between the column swinging point 9 and the column supporting point 32b (LS) is set to be equal to or greater than 30% of the distance between the column swinging point 9 and the steering wheel 3 (LH) in the steering apparatus 1. Thus, the rigid attaching of the steering apparatus 1 to the vehicle body is ensured. The column supporting point 32b is provided at the steering wheel 3 side relative to the column swinging point 9 of the steering column 2. Thus, the load transmitted to the column supporting portion 32b supporting the steering column 2 is decreased. Accordingly, a rigidity of the steering apparatus 1 is improved even when the load in vertical direction (a gravity direction) is applied to the steering wheel 3.

The steering column 2 includes the first link 30 fixed to the steering column 2, the second link 31 rotatable relative to the first link 30 about the first rotation axis, the third link 32 provided between the second link 31 and the vehicle body. The third link 32 is rotatable relative to the second link 32 about the second rotation axis. The link mechanism 33 including these three links prevents a concentration of the load to a limited position. The load is separately transmitted to the column supporting point 32b by the linking mechanism 33. Thus, the rigidity of the steering column is increased.

The steering apparatus 1 includes the driving mechanism 20 supported by the second link 31. The driving mechanism 20 moves the second link 31 relative to the first link 30. The steering column 2 is easily vertically moved by moving the second link 31 relative to the first link 30 by the driving mechanism 20. An amount of the swinging of the steering wheel 3 is simply determined by an amount of the rotation of the second link 31 relative to the first link 30. Accordingly, the rigidity of the steering apparatus 1 is improved, and the large amount of the tilting operation of the steering wheel 3 is ensured.

The steering column 2 changes the length thereof by moving the second column tube 12 relative to the first column tube 11, and by overlapping the second column tube 12 with the first column tube 11. The link mechanism 33 is attached to the member not changing the length thereof (in other words, the member not moving relative to the vehicle body). Accordingly, an interference from the components provided around the steering column to the steering apparatus 1 is prevented even in shrunk condition of the steering apparatus 1.

The engagement of the vehicle body with the third link 32 is released in case the load equal to or greater than predetermined value in the axial direction is applied to the steering wheel 3. By the release of the engagement of the vehicle body with the third link 32, the overlapped portion between the first column 11 and the second column 12 becomes large. Thus, the steering wheel 3 moves in axial direction. Accordingly, a space of the seat for the driver is broaden. As a result, the driver is protected. The safety of the steering apparatus 1 is ensured.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the Claims, be embraced thereby.

1. A steering apparatus comprising:
a steering wheel;
a steering column connected to the steering wheel at one end of the steering column;
a column supporting member rotatably supporting the steering column relative to a vehicle body; and
a column swinging member rotatably supporting the steering column for swinging the steering column about a column swinging point on the column swinging member, wherein
a distance (LS) between the column swinging point and a column supporting point provided at the column supporting member is equal to or greater than 30% of distance (LH) between the column swinging point and the steering wheel.

2. The steering apparatus according to claim 1, wherein the steering column includes
a first link fixed to the steering column;
a second link rotatably attached to the first link about a first rotation axis; and
a third link rotatably attached to the second link about a second rotation axis.

3. The steering apparatus according to claim 2, further comprising:
a driving mechanism supported by the second link for moving the second link relative to the first link.

4. The steering apparatus according to claim 2, wherein the steering column includes
a first column; and
a second column moving to overlap with the first column, wherein either one of the first column or second column is supported by the first link.

5. The steering apparatus according to claim 4, further comprising:
a locking and releasing member for releasing an engagement of the vehicle body with the third link in case a load exceeding a predetermined value is applied to the steering wheel in an axial direction of the steering column, wherein
an overlap between the first column and the second column increases to move the steering wheel in axial direction of the steering column in case the engagement of the vehicle body with the third link is released.
